(19) United States
(12) Patent Application Publication
(10) Pub. No.: US 2005/0099492 A1
(43) Pub. Date: May 12, 2005

(54) Activity controlled multimedia conferencing

(75) Inventor: Stephen J. Orr, Markham (CA)

Correspondence Address: SMART AND BIGGAR, 438 UNIVERSITY AVENUE, SUITE 1500 BOX 111, TORONTO, ON, M5G2K8, CA

(73) Assignee: ATI Technologies Inc.

(21) Appl. No.: 10/695,990

(22) Filed: Oct. 30, 2003

(51) Int. Cl. H04N 7/14

(52) U.S. Cl. 348/14.08; 348/14.01; 348/14.03

(57) ABSTRACT

Multimedia conferencing software and computing devices allow the appearance of a video image of a conference participant to be adjusted in dependence on a level of activity associated with the conference participant. In this way, video images of more active participants may be given greater prominence. An end-user participating in the conference may focus attention on the more active participants.

### FIELD OF THE INVENTION

The present invention relates generally to teleconferencing, and more particularly to multimedia conferencing between computing devices.

### BACKGROUND OF THE INVENTION

In recent years, the accessibility of computer data networks has increased dramatically. Many organizations now have private local area networks. Individuals and organizations often have access to the public internet. In addition to becoming more readily accessible, the available bandwidth for transporting communications over such networks has increased.

Consequently, the use of such networks has expanded beyond the mere exchange of computer files and e-mails. Now, such networks are frequently used to carry real-time voice and video traffic.

One application that has increased in popularity is multimedia conferencing. Using such conferencing, multiple network users can simultaneously exchange one or more of voice, video and other data.

Present conferencing software, such as Microsoft's NetMeeting software, and ICQ software, presents video data associated with multiple users simultaneously, but does not easily allow the data to be managed. The layout of video images is almost always static.

As a result, multimedia conferences are not as effective as they could be.

Accordingly, there is clearly a need for enhanced methods, devices and software that control the display of multimedia conferences.

### SUMMARY OF THE INVENTION

Conveniently, software exemplary of the present invention allows the appearance of a video image of a conference participant to be adjusted in dependence on a level of activity associated with the conference participant. In this way, video images of more active participants may be provided more screen space. An end-user participating in the conference may focus attention on the more active participants.

Advantageously, screen space is more effectively utilized and conferencing is more effective as video images of less active or inactive participants may be reduced in size, or entirely eliminated.

In accordance with an aspect of the present invention, there is provided, at a computing device operable to allow an end-user to participate in a conference with at least two other conference participants, a method of displaying a video image from one of said two other conference participants, said method comprising adjusting an appearance of said video image in dependence on a level of activity associated with said one of said two other conference participants.

In accordance with another aspect of the present invention, there is provided a computing device storing computer executable instructions, adapting said device to allow an end-user to participate in a conference with at least two other conference participants, and adapting said device to display a video image from one of said two other conference participants, and adjust an appearance of said video image in dependence on a level of activity associated with said one of said two other conference participants.

In accordance with yet another aspect of the present invention, there is provided a computing device storing computer executable instructions adapting the device to receive data streams, each having a bitrate and representing video images of participants in a conference, and transcode at least one of said received data streams to a bitrate different than that with which it was received, based on a level of activity associated with a participant originating said stream, and provide output data streams formed from said received data streams to said participants.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate embodiments of the present invention by example only,

FIG. 1 is a hardware overview of a network including several multimedia conference capable computing devices, and a multimedia server exemplary of embodiments of the present invention;

FIG. 2 illustrates an exemplary hardware architecture of a computing device of FIG. 1;

FIG. 3 illustrates exemplary software and data organization on a device on the network of FIG. 1;

FIG. 4 schematically illustrates data exchange between computing devices on the network of FIG. 1 in order to effect a multimedia conference;

FIG. 5 schematically illustrates alternate data exchange between computing devices and the server on the network of FIG. 1 in order to effect a multimedia conference;

FIG. 6 is a flow chart illustrating steps performed at a computing device originating multimedia conferencing data on the network of FIG. 1;

FIG. 7 is a flow chart illustrating steps performed at a computing device receiving multimedia conferencing data on the network of FIG. 1;

FIG. 8 illustrates an exemplary video conferencing graphical user interface, exemplary of an embodiment of the present invention; and

FIGS. 9A-9D further illustrates the exemplary video conferencing graphical user interface of FIG. 8 in operation.

Like reference numerals refer to corresponding components and steps throughout the drawings.

### DETAILED DESCRIPTION

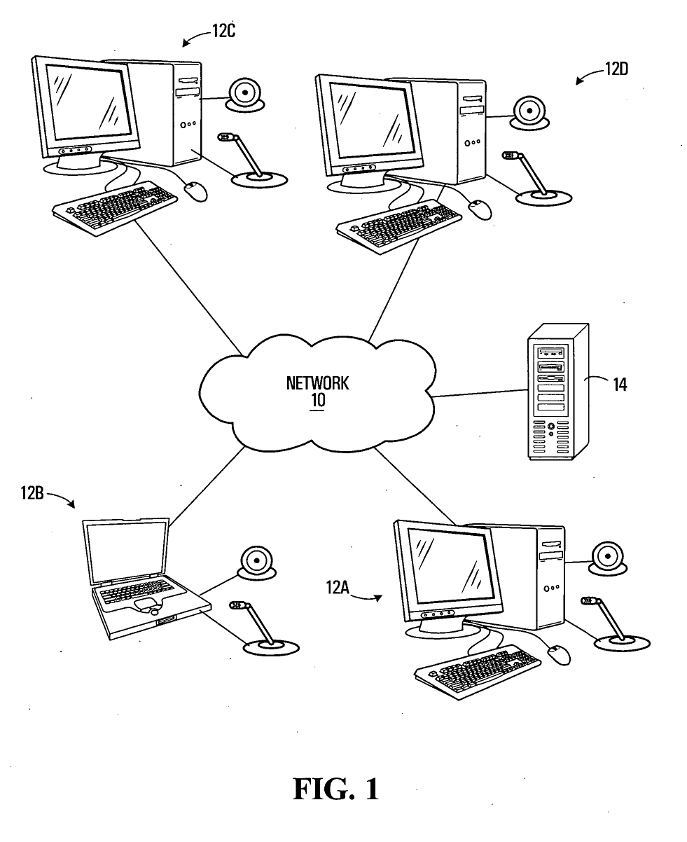

FIG. 1 illustrates an exemplary data communications network 10 in communication with a plurality of multimedia computing devices 12a, 12b, 12c and 12d (individually and collectively devices 12), exemplary of embodiments of the present invention. An optional centralized server 14, acting as a multimedia conference server is also illustrated.

Computing devices 12 and server 14 are all conventional computing devices, each including a processor and computer readable memory storing an operating system and software applications and components for execution.

As will become apparent, computing devices 12 are adapted to allow end-users to become participants in real-time multimedia conferences. In this context, multimedia conferences typically include two or more participants that exchange voice, video, text and/or other data in real-time or near real-time using data network 10.

As such, computing devices 12 are computing devices storing and executing capable of establishing multimedia conferences, and executing software exemplary of embodiments of the present invention.

Data communications network 10 may for example be a conventional local area network that adheres to suitable network protocol such as the Ethernet, token ring or similar protocols. Alternatively, the network protocol may be compliant with higher level protocols such as the Internet protocol (IP), Appletalk, or IPX protocols. Similarly, network 10 may be a wide area network, or the public internet.

Optional server 14 may be used to facilitate conference communications between computing devices 12 as detailed below.

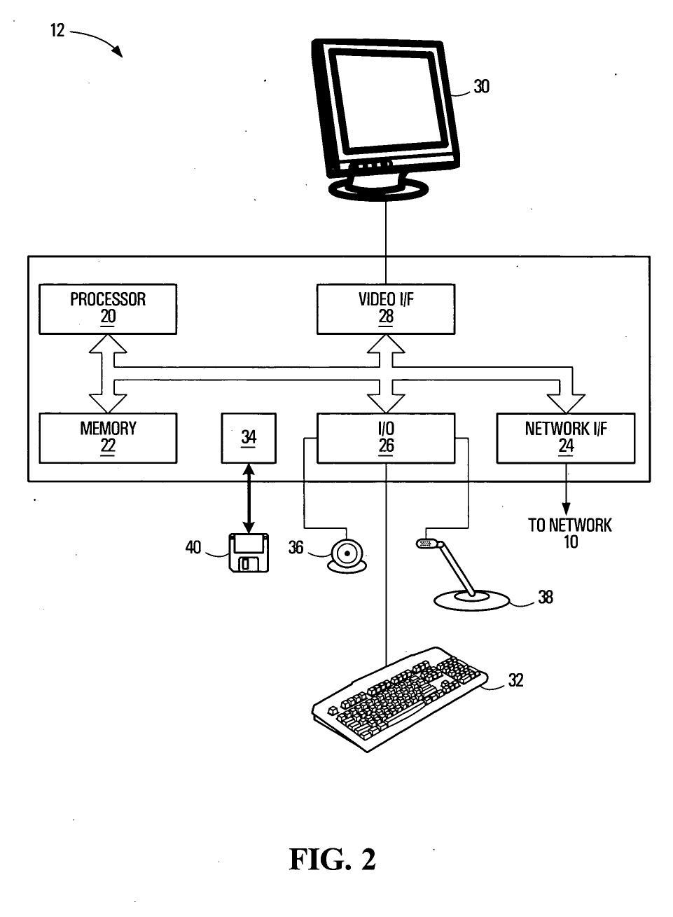

An exemplary simplified hardware architecture of computing device 12 is schematically illustrated in FIG. 2. In the illustrated embodiment, device 12 is a conventional network capable multimedia computing device. Device 12 could, for example, be an Intel x86 based computer acting as a Microsoft Windows NT/XP/2000, Apple, or Unix based workstation, personal computer or the like. Example device 12 includes a processor 20, in communication with computer storage memory 22; data network interface 24; input output interface 26; and display adapter 28. As well, device 12 includes a display 30 interconnected with display adapter 28; input/output devices, such as a keyboard 32 and disk drive 34, camera 36, microphone 38 and a mouse (not shown) or the like.

Processor 20 is typically a conventional central processing unit, and may for example be a microprocessor in the INTEL x86 family. Of course, processor 20 could be any other suitable processor known to those skilled in the art. Computer storage memory 22 includes a suitable combination of random access memory, read-only-memory, and disk storage memory used by device 12 to store and execute software programs adapting device 12 to function in manners exemplary of the present invention. Drive 34 is capable of reading and writing data to or from a computer readable medium 40 used to store software to be loaded into memory 22. Computer readable medium 40 may be a CD-ROM, diskette, tape, ROM-Cartridge or the like. Network interface 24 is any interface suitable to physically link device 12 to network 10. Interface 24 may, for example, be an Ethernet, ATM, ISDN interface or modem that may be used to pass data from and to network 10 or another suitable communications network. Interface 24 may require physical connection to an access point to network 10, or it may access network 10 wirelessly.

Display adapter 28 may includes a graphics co-processor for presenting and manipulating video images. As will, become apparent, adapter 28 may be capable of compressing of compressing and de-compressing video data.

The hardware architectures of server 14 is materially similar to that of device 12, and will be readily appreciated by a person of ordinary skill. It will therefore not be further detailed.

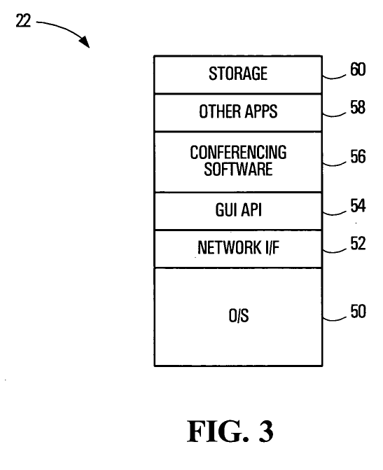

FIG. 3 schematically illustrates exemplary software and data stored in memory 22 at the computing devices 12 illustrated in FIG. 1.

As illustrated computing devices 12 each store and execute multimedia conferencing software 56, exemplary of embodiments of the present invention. Additionally, exemplary computing devices 12 store and execute operating system software 50, which may present a graphical user interface to end-users. Software executing at device 12 may similarly present a graphical user interface by way of graphical user interface application programming interface 54 which may include libraries and routines to present a graphical interface that have a substantially consistent look and feel.

In the exemplified embodiment, operating system software 50 is a Microsoft Windows or Apple Computing operating system or a Unix based operating system including a graphical user interface, such as X-Windows. As will become apparent, video conferencing software 56 may interact with operating system software 50 and GUI programming interface 54 in order to present an end-user interface as detailed below.

As well, software networking interface component 52 allowing communication over network 10 is also stored for execution at each of device 12. Networking interface component 52 may, for example, be an internet protocol stack, enabling communication of device 12 with server 14 using conventional internet protocols and/or other computing devices.

Other applications 58 and data 60 used by applications and operating system software 50 may also be stored within memory 22.

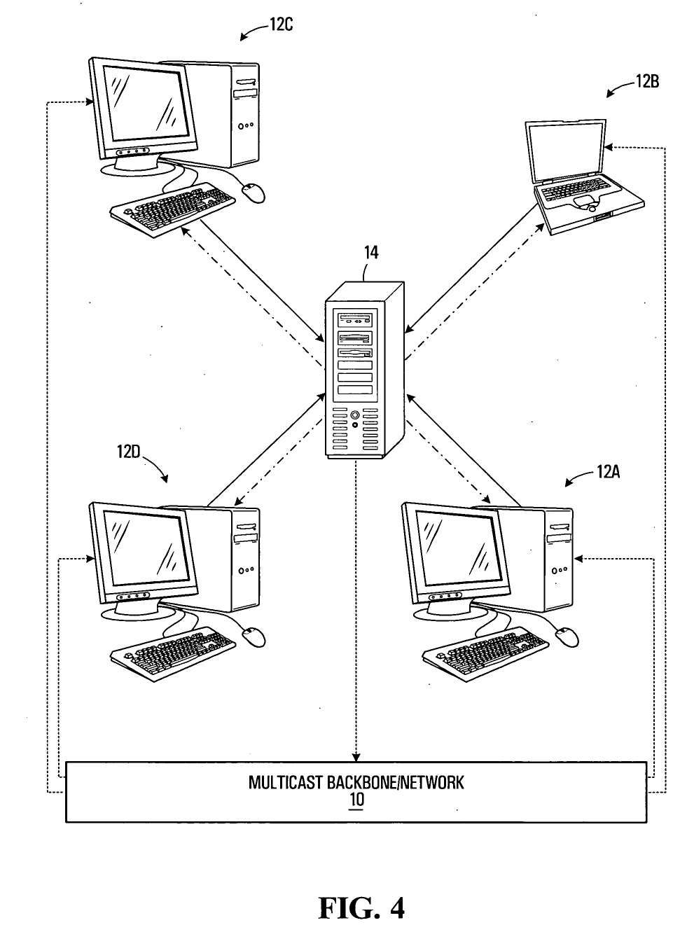

Optional server 14 of FIG. 1 includes multimedia conferencing server software (often to as “reflector” software). Server 14 allows video conferencing between multiple computing devices 12, communicating in a star configuration as illustrated in FIG. 4. In this configuration, video conferencing data shared amongst devices 12 is transmitted from each device 12 to server 14. Conferencing server software at server 14 re-transmits (or “reflects”) multimedia data received from each member of a conference to the remaining members, either by unicasting multimedia data to each other device 12, or by multi-casting such data using a conventional multi-cast address to a multicast backbone of network 10. Devices 12, in turn may receive data from other conference participants from unicast addresses from server 14, or by listening to one or more multicast addresses from network 10.

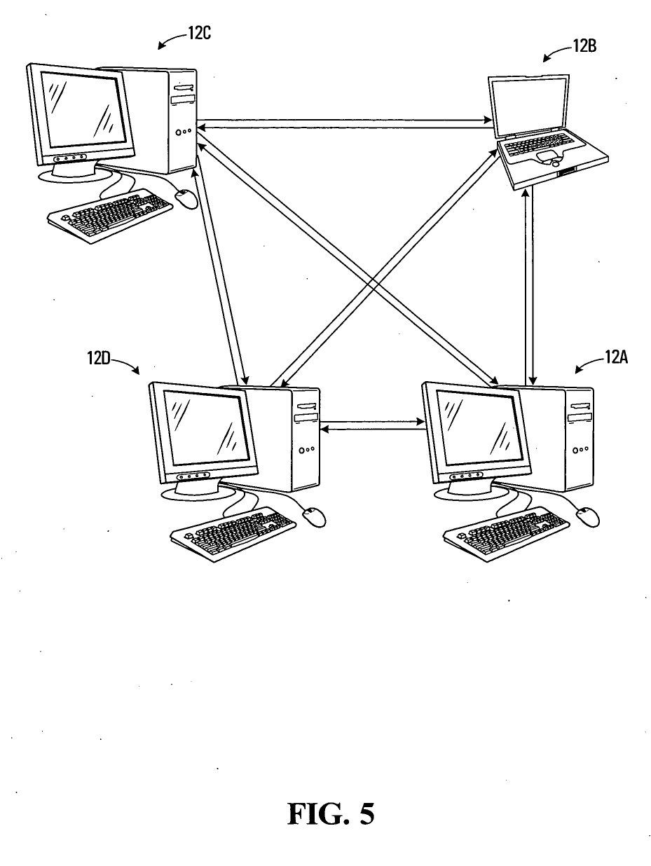

In an alternate configuration, devices 12 may communicate with each other, using point-to-point communication as illustrated in FIG. 5. As each device 12 transmits originating multimedia data to each other device 12, significantly more network bandwidth is required. Alternatively, each device 12 could multicast originating multimedia, for receipt by the each remaining device 12.

In any event, conferencing software 56 may easily be adapted to establish connections as depicted in either or both FIGS. 4 and 5, as described herein.

In operation, users wishing to establish or join a multimedia conference execute conferencing software 56 at a device 12 (for example device 12a). Software 56 in turn requests the user to provide a computer network address of a server, such as server 14. In the case of point-to-point communication, device 12a may contact other computing devices, such as devices 12b-12d. Device 12a might accomplish this by initially contacting a single other computing device, such as device 12b, which could in turn, provide addresses of other conferencing devices (e.g. device 12c) to device 12a. Network addresses may be known internet protocol addresses of conference participants, and may be known by a user, stored at devices 12, or be distributed by another computing device such server 14.

Once a connection to one or more other computing devices 12 has been established, example device 12a presents a graphical user interface on its display 30 allowing a conference between multiple parties. Computing device 12a originates transmission of multimedia data collected at device 12a to other conference participants. At the same time, computing device 12a presents data received from other participants (e.g. from devices 12b, 12c or 12d) at device 12a.

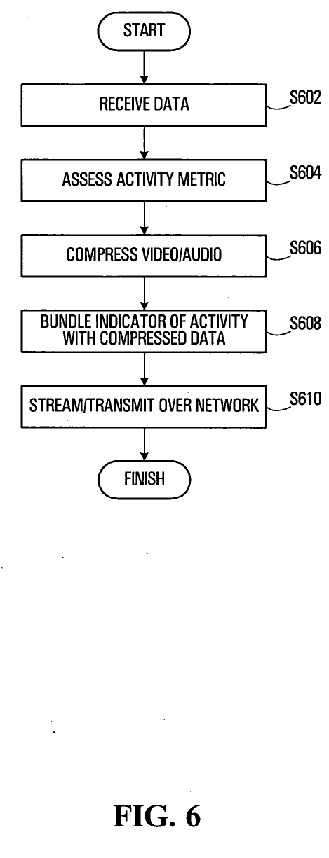

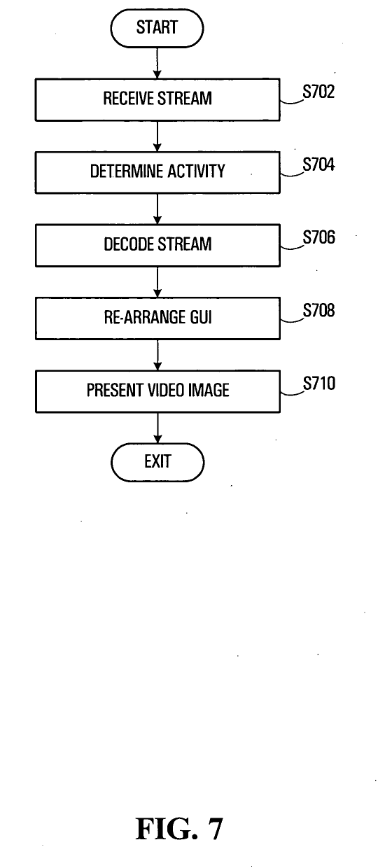

Steps S600 performed at device 12a under control of software 56 to collect input originating with an associated conference participant at device 12a are illustrated in FIG. 6. Steps S700 performed at device 12a in presenting data received from other conference participants are illustrated in FIG. 7. Like steps are preformed at each device (e.g. device 12a, 12b, 12c and/or 12d) that is participating in the described conference.

As illustrated in FIG. 6, computing device 12a receives data from an associated end-user at device 12a in step S602. Device 12a may, for example receive video data by way of camera 36 and/or audio by way of microphone 38 (FIG. 2). Additionally, or alternatively user interaction data may be obtained by way of keyboard 32, mouse or other peripherals. Software 56 converts audio and video and other data to a suitable multimedia audio/video stream in step S606. For example, sampled audio and video may be assembled and compressed in compliance with International Telephone Union (ITU) Recommendation H.323, as a motion picture experts group (MPEG) stream, as a Microsoft Windows Media stream, or other streaming multimedia format. As will be readily appreciated, video compression performed in step S606 may easily be performed by a graphics co-processor on adapter 28.

Prior to transmission of the stream by way of network 10, computing device 12a preferably analyses the sampled data to assess a metric indicative of the activity of the participant at device 12a, in step S604 as detailed below. An indicator of this metric is then bundled in the to-be transmitted stream in step S608. In the exemplified embodiment, the metric is a numerical value or values reflecting the activity of the end-user in the conference at device 12a originating the data. In the disclosed embodiment, the example indicator is bundled with the to-be-transmitted stream so that it can be extracted without decoding the encoded video or audio contained in the stream.

Multimedia data is transmitted over network 10 in step S610. Multimedia data may be packetized and streamed to server 14 in step S610, using a suitable networking protocol in co-operation with network interface component 52. Alternatively, if computing device 12a communicates with other computing devices directly (as illustrated in FIG. 5), a packetized stream may be unicast from device 12a to each other device 12 that is a member of the conference. Alternatively, each device 12 may multicast the packets.

An activity metric for each participant is preferably assessed by the computing device originating a video stream in step S604. As will be readily appreciated, an activity metric may be assessed in any number of conventional ways. For example, the activity metric for any participant may, for example, be assessed based on various energy levels in the signal in a compressed video signal in step S604. For example, as part of video compression it is common to monitor changed and/or moved pixels or blocks of pixels that can in turn be used to gauge the amount of motion in the video. For example, the number of changed pixels from frame to frame or rate of pixel change over several frames may be calculated to assess the activity metric. Alternatively, the activity metric could be assessed using the audio portion of the stream: for example the root-mean-square power in the audio signal may be used to measure the level of activity. Optionally, the audio could be filtered to remove background noise, improving the reliability of this measure. Of course, the activity metric could be assessed using any suitable combination measurements derived from data collected from the participant. Multiple independent measures of activity could be combined to form the ultimate activity metric transmitted or used by a receiving device 12.

A participant who is very active (e.g. talking and moving) would be associated with a high valued activity metric. A participant who is less active (e.g. talking but not moving) could be attributed a lower valued activity metric. Further, a participant who is moving but not talking could be assigned an even lower valued activity metric. Finally a person who is neither talking nor moving would be given an even lower activity metric. Activity metrics could be expressed as a numerical value in a numerical range (e.g. 1-10), or as a vector including several numerical values, each reflecting a single measurement of activity (e.g. video activity, audio activity, etc.).

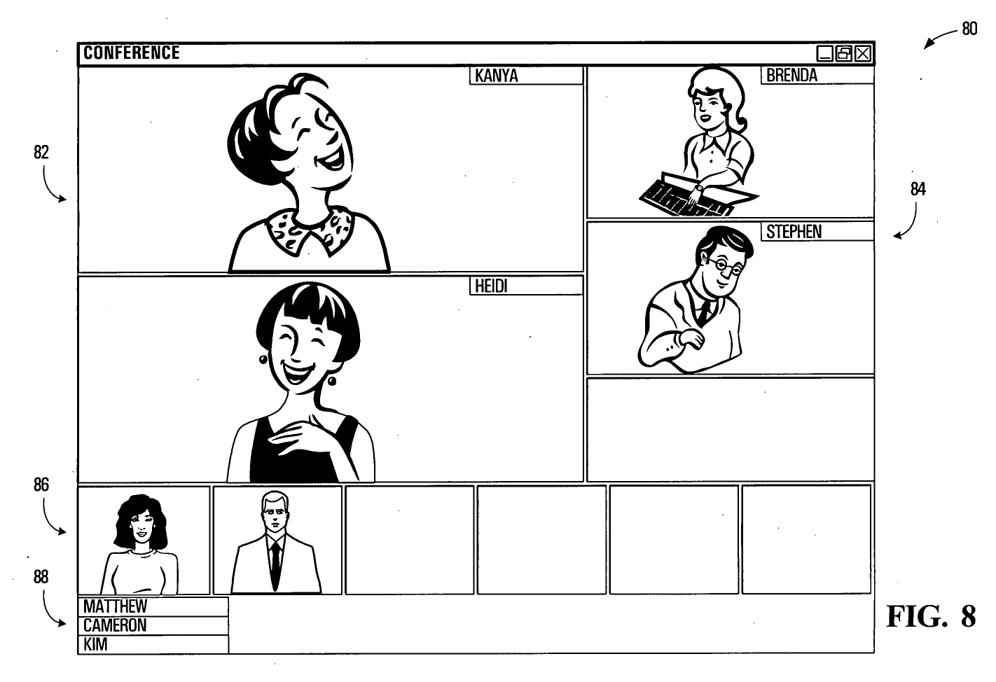

At the same time, as it is transmitting data a participant computing device 12 (e.g. device 12a) receives streaming multimedia data from other multimedia conference participant devices, either from server 14, from a multicast address of network 10, or transmissions from other devices 12. Steps S700 performed at device 12a are illustrated in FIG. 7. Data may be received in step S702. Device 12a may in turn extract a provided indicator of the activity metric added by an upstream computing device (as, for example, described with reference to step S608), in step S704 and decode such received stream in step S706. Audio/video information corresponding to each received streams may be presented by way of a user interface 80, illustrated in FIG. 8.

Now, exemplary of the present invention, software 56 controls the appearance of interface 80 based on activity of the conference participant. Specifically, computing device 12a under control of software 56 assesses the activity associated with a particular participant in step S704. This may be done by actually analysing the incoming stream associated with the participant, or by using an activity metric for the participant, calculated by an upstream computing device, as for example calculated by the originating computing device in step S604.

In response, software 56 may resize, reposition, or otherwise alter the video image associated with each participant based on the current and recent past level of activity of that participant as assessed in step S704. As illustrated, example user interface 80 of FIG. 8 presents images in multiple regions 82, 84, and 86. Each region 82, 84, 86 provides video data from one or more multicast participants at a device 12. As will be apparent, the size allocated to video data from each participant differs from region to region. Largest images are presented in region 82. Preferable, each conference participant is allocated an individual frame or window within one of the regions. Optionally, a conference participant may be allocated two or more frames, windows or the like: one may for example display video; the other may display text or the like.

At device 12a, software 56, in turn, decodes video in step S706 and presents decoded video information for more active participants in larger display windows or panes of graphical user interface 80. Of course, decoding could again be performed by a graphical co-processor on adapter 28. In an exemplary embodiment, software 56 allows an end-user to define the layout of graphical user interface 80. This definition could include the size and number of windows/panes in each region, to be allocated to participants having a particular activity status.

In exemplary graphical user interface 80, the end-user has defined four different regions, each used to display video or similar information for participants of like status. Exemplary graphical user interface 80 includes region 82 for highest activity participants, region 84 for lower activity participants; region 86 for even lower activity participants; and region 88 for lowest activity participants that are displayed. In the illustrated embodiment, region 88 simply displays a list of least active (or inactive) participants, without decoding or presenting video or audio data.

Alternatively, software 56 may present image data associated with each user in a separate window and change focus of presented windows, based on activity, or otherwise alter the appearance of display information derived from received streams, based on activity.

Each region 82, 84, 86, 88 could be used to display video data associated with participants having like activity metrics. As will be appreciated each region could be used to represent video for participants having ranges of metric. Again suitable ranges could be defined by an end-user viewing graphical user interface 80 using device 12 executing software 56.

With enough participants, those that have activity metric below a threshold for a determined time may be removed from regions 82, 84 or 86 representing the active part of graphical user interface 80 completely and placed on a text list in region 88. This list in region 88 would thus effectively identify by text or symbol participants who are essentially observing the multimedia conference, without actively taking part.

As participants become more or less active their activity is re-calculated in step S604. As status changes, graphical user interface 80 may be redrawn and participant's allocated space may change to reflect newly determined status in step S708. Video data for any participant may be relocated and resized based on that participant's current activity status.

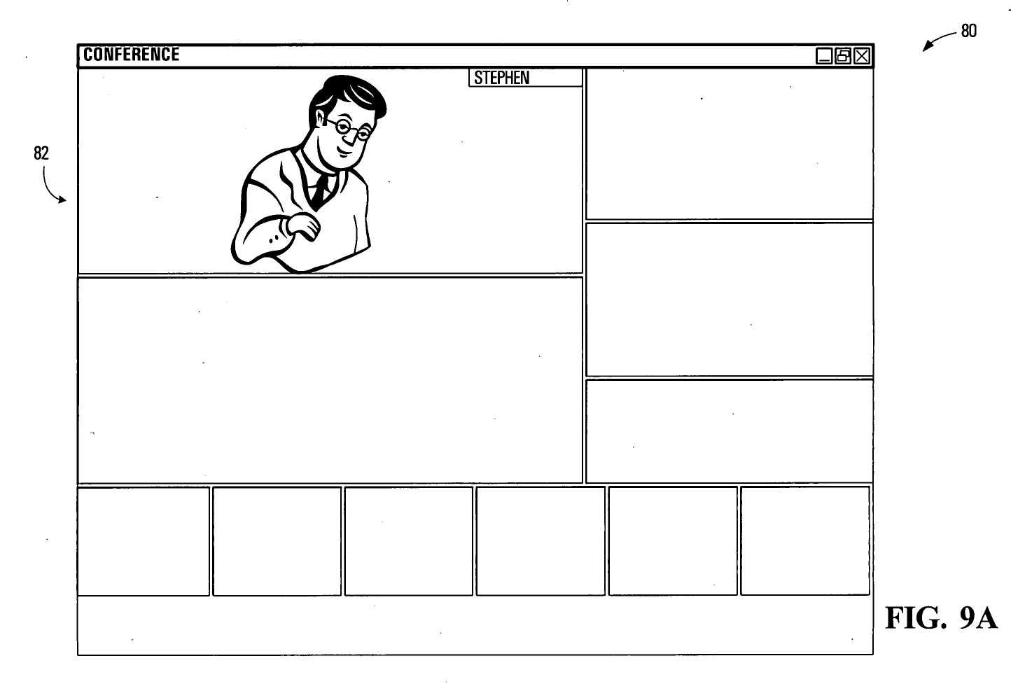

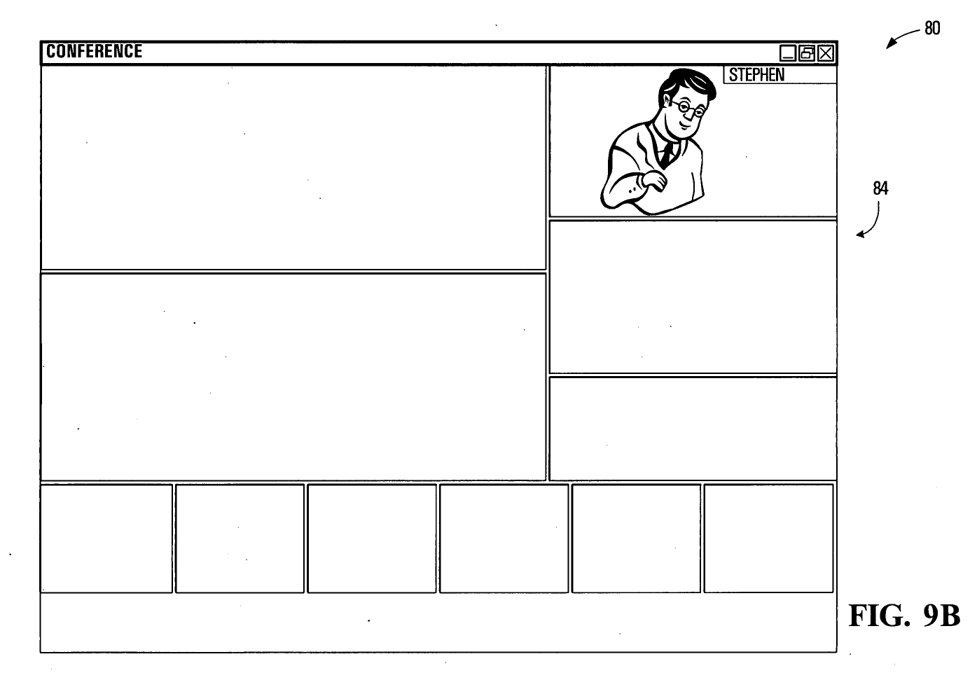

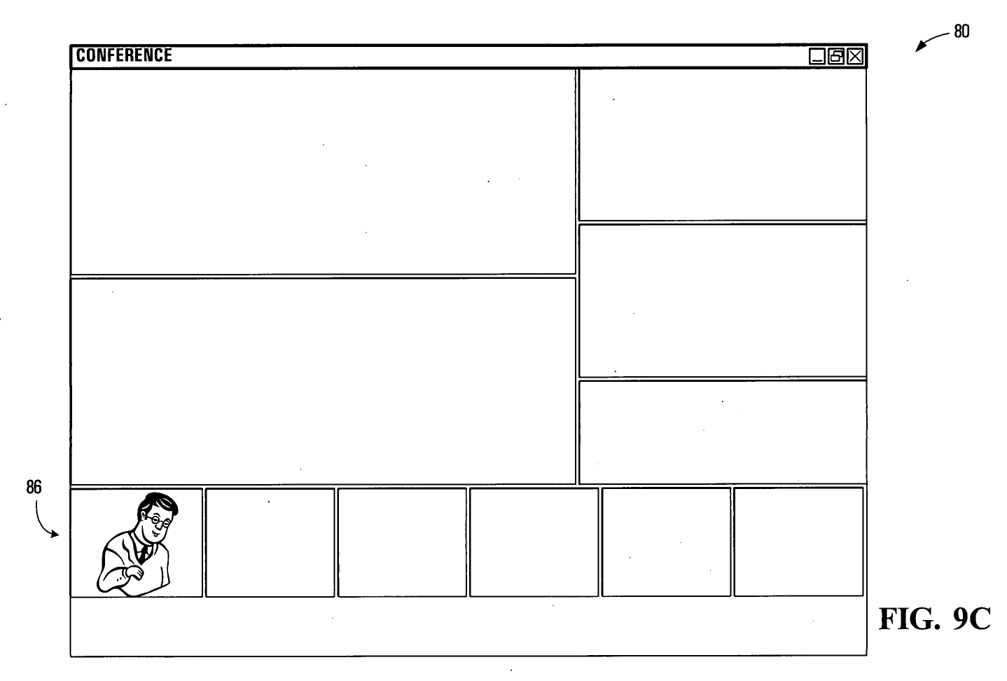

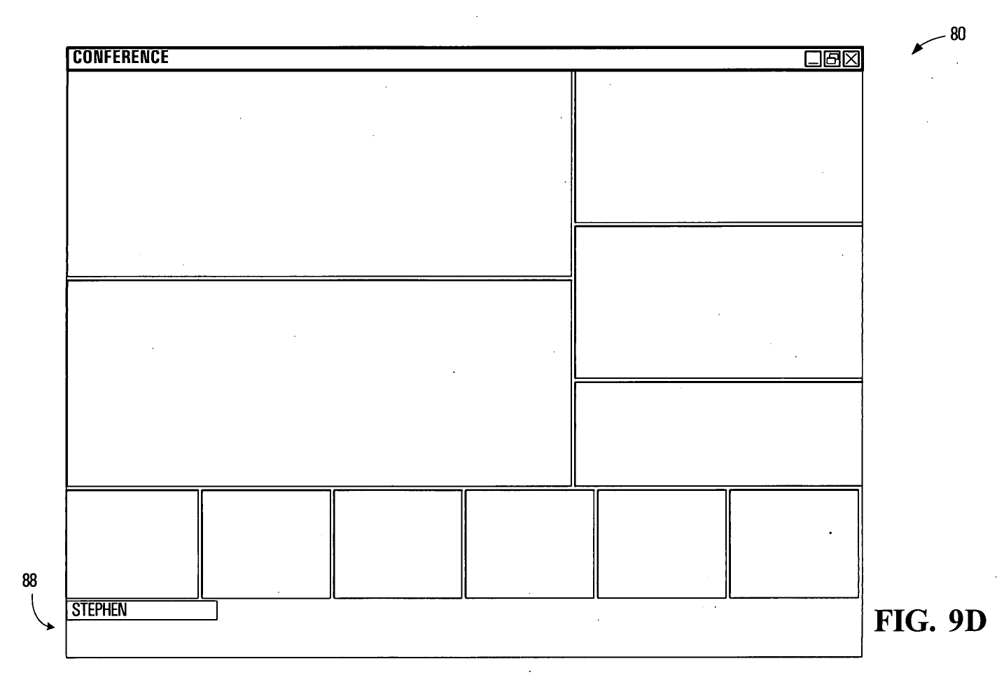

As one participant in a conference becomes more and more active, a recipient computing device 12 may allocate more and more screen space to that participant. Conversely, as a participant becomes less and less active, less and less space could be allocated to video associated with that participant. This is, for example, illustrated for a single participant, “Stephen”, in FIGS. 9A-9D. It may be required that the amount of allocated display space be a progression from activity region to activity region, as for example illustrated in FIGS. 9A-9D as an associated activity metric for that participant increases or decreases, or it may be possible to move directly from a high activity state (as illustrated in FIG. 9A) to a low activity one (as illustrated in FIG. 9D).

Additionally, as the activity status of a participant changes, the audio volume of participants with lower activity status may be reduced or muted in step S708. Presented audio may be the product of multiple mixed audio streams. Only audio of streams of participants having activity metrics above a threshold need be mixed.

In the exemplified graphical user interface 80, only four regions 82, 84, 86 and 88 are depicted. Depending on the preferred display layout/available space there may be room for a fixed number of high activity participants and a larger number of secondary and tertiary activity participants. The end user at the device presenting graphical user interface 80 may choose a template that determines the number of highest activity, second highest activity, etc. conference participants. Alternatively, software 56 may calculate an optimal arrangement based on the number of participants, and relatively display sizes of each region. In the latter case the size allocated for any participant may be chosen/changed dynamically based on the number of active and inactive participants.

An end user viewing interface 80 may also choose to pin the display associated with any particular participant, to prevent or suspend its size and/or position from changing with the activity of that participant (for example to ensure that a shared whiteboard is always visible) or to limit how small the video associated with a specific participant is allowed to slide (allowing a user to “keep an eye on” a specific participant). This may be particularly beneficial when one of the presented windows/panes includes other data, such as for example text data. Software 56, in turn, may allocate other video images/data around the constrained image. Alternately a user viewing interface 80 may choose to deliberately entirely eliminate the video for a participant that the user does not want to focus any attention on. These are manual selections that may be input, for example, using key strokes, mouse gestures, or menus on graphical user interface 80.

Additionally, software 56 could present an alert identifying inactive participants identified within graphical user interface 80. For example, video images of persistently inactive participants could be highlighted with a colour, or icon. This might allow a participant acting as a moderator to ensure participation by inactive participants, calling on those identified as inactive. This may be particularly useful for “round-robin” discussions, where each participant is expected to remain active, made by way of multimedia conference.

Further, software 56 may otherwise highlight the level of activity of participants at interface 80. For instance, participants with a high activity metric could have associated video presented in a coloured border. This allows a person to focus their attention on active participants, even if those participants have been forced to a lower activity region by a user, allowing an end-user to follow the most active speaker even if that participant's video image has been forcibly locked to a particular region.

As noted, the activity metric is preferably calculated when the video is compressed (at the source). A numerical indicator of the metric is preferably included in a stream so that it may be easily parsed by a downstream computing device and thus quickly used to determine the activity metric. Conveniently, this allows all of the downstream computing devices to make quick and likely computationally inexpensive decisions as to how to treat a stream from an end-user computing device 12 originating the stream. Recipient computing devices 12 would thus not need to calculate an activity indicator for each received stream. Similarly, for inactive participants, a downstream computing device need not even decode a received stream if associated video and/or audio data is not to be presented, thereby by-passing step S706.

In alternate embodiments, activity metrics could be calculated downstream of the originating participants. For example, an activity metric could be calculated at server 14, or at a recipient device 12.

Optionally, server 14 may reduce overall bandwidth by considering the activity metric associated with each stream and avoiding a large number of point-to-point connections, for streams that have low activity. For example, for a low activity stream conferencing software at server 14 might take one (or several) of a number of bandwidth saving actions before re-transmitting that stream. For example, conferencing software at server 14 may strip the video and audio from the stream and multicast the activity metrics only; stop sending anything to the recipient; send cues back to the upstream originating computing device to reduce the encode bitrate/frame rate, or the like; send cues back to the originating computing device to stop transmission entirely until activity resumes; and/or stop sending video but continue to send audio. Similarly, conferencing server 14 could transcode received streams, to lower bitrate video streams. Lower bitrate streams could then be transmitted to computing devices 12 that are displaying an associated image at less than the largest size.

In the event that transmissions between devices 12 is effected point-to-point, as illustrated in FIG. 4, devices 12 could exchange information about the nature of an associated participant's display at a recipient device. In turn, an originating device 12 (such as device 12a) could possibly encode several versions of the originated data in step S606 and transmit a particular compressed version to any particular recipient device 12 (such as device 12b, 12c, and 12d) in step S610, based on the size that a specific recipient is displaying the originator's video. Those devices displaying video associated with an originator in a smaller display area could be provided with lower bitrate streamed video data in step S610. Advantageously, this would reduce overall network bandwidth for point-to-point data exchange.

Additionally, participants who remain inactive for prolonged periods may optionally be dropped from a conference to reduce overall bandwidth. For example server 14, may simply terminate the connection with a computing device of an inactive participant.

Moreover, during decoding, the quality of video decoding for each stream in step S706 at a recipient device 12 may optionally be dependent on the associated activity metric for that stream. That is, as will be appreciated, low bit-rate video streams such as those generated by devices 12 often suffer from “blocking” artefacts. These artefacts can be significantly removed through the use of known filtering algorithms, such as “de-blocking” and “de-ringing” filtering. These algorithms, however, are computationally intensive and thus need not be applied to video that is presented in smaller windows, or otherwise having little video motion. Accordingly, a computing device 12 presenting interface 80 may allocate computing resources to ensure the highest quality decoding for the most active (and likely most important) video streams, regardless of the quality of encoding.

Additionally, encoding/decoding quality may be controlled relatively. That is, server 14 or each computing device 12 may utilize a higher bandwidth/quality of encoding/decoding for the statistically most active streams in a conference. That is, activity metrics of multiple participants could be compared to each other, and only a fraction of the participants could be allocated high bandwidth/high quality encoding, while those participants that are less active (when compared to the most active) could be allocated a lower bandwidth or encoded/decoded using an algorithm that requires less computing power. Well understood statistical techniques could be used to assess which of a plurality of streams are more active than others. Alternatively, an end-user selected threshold may be used, to delineate streams entitled to high quality compression/high bandwidth from those that are not. Signalling information indicative of which of a plurality of streams has higher priority could be exchanged between devices 12.

As will also be appreciated, immediate changes in user interface 80 in response to change in an assessed metric may be disruptive. Rearrangement of user interface 80 in response to changes in a participant's activity should be damped. Accordingly then software 56 in step S708 need only rearrange graphical user interface 80 after the change in a metric for any particular participant persists for a time. However, change from low activity to high activity for a participant may cause a recipient to miss significant portion of an active participant's contribution as that participant becomes more active. To address this, software 56 may cache incoming streams with an activity metric below a desired threshold, for example for 4.5 seconds. If a user has become more active the cached data may be replayed at recipient devices at 1.5× normal speed to allow display of cached data in a mere 3 seconds. If the increased activity does not persist, the cache need not be used and may be discarded. Fast playback could also be pitch corrected to sound natural.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

1. At a computing device operable to allow an end-user to participate in a conference with at least two other conference participants, a method of displaying a video image from one of said two other conference participant, said method comprising:
adjusting an appearance of said video image in dependence on a level of activity associated with said one of said two other conference participants.

2. The method of claim 1, further comprising:
repeatedly adjusting said appearance during said conference.

3. The method of claim 2, wherein said adjusting comprises sizing said image in dependence on said level of activity.

4. The method of claim 2, wherein said adjusting further comprises presenting audio associated with said video image at a volume that varies in dependence on said level of activity.

5. The method of claim 3, further comprising:
displaying said image in a region of said display where images of conference participants having like levels of activity are displayed.

6. The method of claim 5, wherein said end-user defines an appearance of a graphical user interface for said conference, including said region for displaying said image.

7. The method of claim 2, wherein said adjusting comprises highlighting said video image with a colour indicating a level of activity.

8. The method of claim 2, further comprising:
receiving a metric indicative of said level of activity of said other conference participant.

9. The method of claim 8, further comprising:
decoding said video image from a stream of data received by way of a network interconnecting said computing devie with computing devices of said other conference participants.

10. The method of claim 9, further comprising:
extracting said metric from said stream of data prior to said decoding.

11. The method of claim 1, further comprising:
sampling and encoding an image of said end-user and calculating a metric indicative of an activity associated with said end-user to be received by other computing devices in said conference.

12. The method of claim 10, wherein a quality of said decoding said video image is based on an associated metric.

13. The method of claim 12, further comprising:
buffering an incoming stream, to allow a buffered image to be displayed as said level of activity increases.

14. The method of claim 13, further comprising:
encoding video associated with said end-user for transmission by way of said network.

15. The method of claim 14, further comprising assessing a level of activity of said end-user and wherein said encoding video associated with said end-user comprises varying a quality of said encoding in dependence on said level of activity of said end-user.

16. The method of claim 11, wherein said calculating calculates said metric based on an amount of motion detected in said image of said end-user.

17. The method of claim 11, wherein said calculating comprises assessing a volume of audio originating with said end-user.

18. The method of claim 9, further comprising:
receiving said video image from a server.

19. The method of claim 18, wherein said server ceases to provide said video image if said level of activity is below a threshold.

20. The method of claim 1, further comprising receiving an input of an end-user to suspend said adjusting.

21. A computer readable medium, storing computer executable instructions adapting a computing device to perform the method of claim 1.

22. A computing device storing computer executable instructions, adapting said device to allow an end-user to participate in a conference with at least two other conference participants, and adapting said device to display a video image from one of said two other conference participants and adjust an appearance of said video image in dependence on a level of activity associated with said one of said two other conference participant.

23. A computing device storing computer executable instructions adapting said device to
receive data streams, each having a bitrate and representing video images of participants in a conference;
transcode at least one of said received data streams to a bitrate different than that with which it was received, based on a level of activity associated with a participant originating said stream;
provide output data streams formed from said received data streams to said participants.

24. The device of claim 23, wherein said software further adapts said server to not output data streams associated with inactive participants, as indicated by a level of activity associated with each of said participants and included in one of said received data streams.
